(19) United States
(12) Patent Application Publication
(10) Pub. No.: US 2006/0004929 A1
(43) Pub. Date: Jan. 5, 2006

(54) Method and apparatus for recovering from inefficient behavior of devices on I/O buses

(75) Inventors: Thomas R. Forrer JR., Round Rock, TX (US); Asghar Tavasoli, Austin, TX (US); Vahid Tyau, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/880,718

(22) Filed: Jun. 30, 2004

(51) Int. Cl. G06F 13/10

(52) U.S. Cl. 710/15

(57) ABSTRACT

A method, system and computer instructions for mitigating and recovering from the inefficient behavior of one or more peripheral devices attached to a shared I/O bus are disclosed. In one implementation, a Host Bus Adapter (HBA) for a drive monitors the time duration that a shared bus is busy, and can cause an interruption of the operation of that drive if a predetermined time threshold is exceeded. The HBA for that drive can cause the bus to be reset, if necessary, and can cause the target device utilizing the bus to be disconnected so that another target device can access the bus. Alternatively, the HBA for a drive can note that the bus is busy and restart any timers needed if relatively lengthy bus operations occur.

### BACKGROUND OF THE INVENTION

1. Technical Field

The present invention is related generally to Input/Output (I/O) interfaces between computers and peripheral devices. In particular, the present invention provides an improved method and apparatus for mitigating and recovering from the inefficient behavior of one or more peripheral devices attached to an I/O bus that supports the SCSI protocol.

2. Description of Related Art

The Small Computer System Interface (SCSI) standard is used for Personal Computers (PCs), Linux systems, AIX/UNIX systems, and Storage Subsystems to attach peripheral devices to the systems involved. Numerous peripheral devices (e.g., hard disk drives, tape drives, CD-ROM drives, storage subsystems, etc.) can be attached to a single SCSI initiator.

The SCSI protocol can be used on either serial or parallel physical connections such as SAS (Serial Attached SCSI), FC (Fiber Channel), or parallel SCSI. These physical interfaces can be used to connect a wide variety of peripheral devices to PCs and other computer systems. However, due to SCSI protocol issues, SCSI devices can interfere with each others' operation. For example, in accordance with the SCSI protocol, numerous peripheral devices (e.g., disk drives, tape drives, CD-ROM drives, etc.) can be attached to the same parallel SCSI I/O bus. However, each such peripheral device can have a different service time requirement. In other words, a typical service requirement for hard disk drive media access operations on a shared I/O bus, such as hard disk read or write operations, is that the I/O operations be completed within 30 seconds or less. In any event, typical disk drive read/write operations on shared I/O buses can be completed in less than a second. In contrast, tape drive media access (read/write) operations on a shared I/O bus can take more than 30 minutes to complete. Consequently, this disparity between service time requirements for different types of peripheral devices serves to tie up the I/O bus and, therefore, significantly degrades the overall performance of the host system involved.

In most circumstances, a tape drive will disconnect from a shared I/O bus (e.g., when the tape drive has no data in its cache or needs no data from the host). Nevertheless, there are numerous circumstances when a tape drive should not be disconnected from a bus. For example, some tape drives are configured so they cannot disconnect from a bus. Also, tape drives performing internal error recovery procedures sometimes do not disconnect even when they should because of bugs in the product design.

If a peripheral device (e.g., tape drive) is connected to a shared I/O bus for an extended period of time, the Adapter Device Driver (ADD) associated with that device can reset the bus. The SCSI Bus Reset should cause the bus to go Bus Free and allow other peripheral devices (e.g., hard disk drives, CD-ROM drives) to complete their I/O operations.

However, a significant problem with such reset processes is that if a host operating system's root volume group or boot drive is operating on a hung-up I/O bus, the system pauses noticeably until the bus is reset. Depending on the operating system involved, an entry in the system error log can result in an inappropriate service action that recommends the replacement of the hard drive, because the hard drive is likely the device that the error condition (e.g., command time-out) is logged against.

The SCSI protocol defines a methodology that can be used to distribute the SCSI I/O bus bandwidth fairly based on the address assigned to the SCSI device (known as SCSI Arbitration Fairness). Also, the SCSI protocol attempts to manage I/O bus bandwidth utilization with Mode Page 2 Disconnect/Reconnect parameters in conjunction with the Disconnect/Reconnect Permission Bit located in the Identify Message. However, the SCSI protocol does not provide such a methodology for any peripheral device that fails to support or implement these disconnect/reconnect parameters correctly, and therefore, fails to use the SCSI bandwidth efficiently during the SCSI Bus data transfer bus phase. Thus, there is a need for a method and apparatus for mitigating and recovering from the inefficient behavior of one or more peripheral devices attached to a shared I/O bus.

### SUMMARY OF THE INVENTION

The present invention provides a method, system and computer instructions for mitigating and recovering from the inefficient behavior of one or more peripheral devices attached to a shared I/O bus. In a preferred embodiment, a Host Bus Adapter (HBA) for a drive monitors the time duration that a shared bus is busy, and can cause an interruption of the operation of that drive if a predetermined time threshold is exceeded. The HBA for a drive can cause the bus to be reset and causes the target device utilizing the bus to be disconnected so that other target devices can access the bus. Alternatively, the HBA for a drive can note that the bus is busy and restart any timers needed if relatively lengthy bus operations occur. In accordance with a preferred embodiment of the present invention, an HBA for a disk drive provides a bus utilization timer function. An Adapter Device Driver (ADD) is used to read and write timer information from and to the timer. The HBA returns an interrupt to the ADD if the HBA determines that the bus has been busy for longer than the threshold value set in the timer. In response, the ADD initiates an appropriate error recovery operation that includes resetting the bus, if necessary. The HBA timer value can be based on the maximum time interval that any particular device is allowed to remain operating on the bus.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of an exemplary data processing system in which a preferred embodiment of the present invention may be implemented;

FIG. 2 depicts a block diagram of an exemplary data processing system in which the present invention may be implemented;

FIG. 3 depicts a block diagram of an exemplary HBA in which a preferred embodiment of the present invention may be implemented; and

FIG. 4 depicts a flow chart of an exemplary method for mitigating and recovering from the inefficient behavior of one or more peripheral devices on a shared I/O bus in accordance with a preferred embodiment of the present invention.

### DETAILED DESCRIPTION OF THE PREFERRED EMBODIMENT

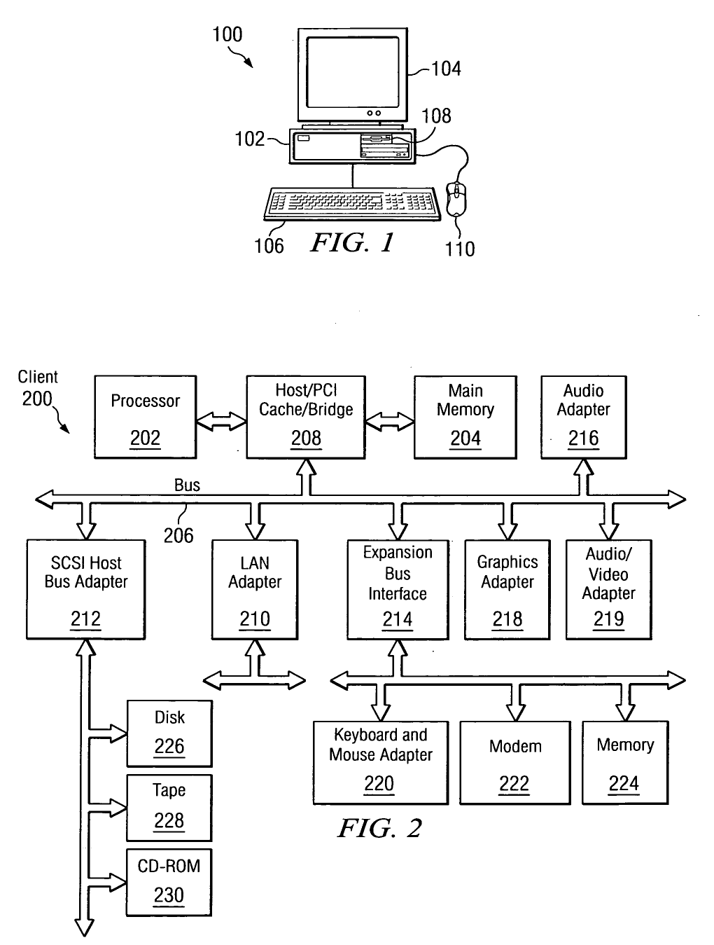

With reference now to the figures and in particular with reference to FIG. 1, a pictorial representation of a data processing system in which the present invention may be implemented is depicted in accordance with a preferred embodiment of the present invention. Computer 100 is depicted which includes system unit 102, video display terminal 104, keyboard 106, storage devices 108, which may include a hard drive, floppy drive, CD-ROM drive and other types of permanent and removable storage media, and mouse 110. Additional input devices may be included with computer 100, such as, for example, a joystick, touchpad, touch screen, trackball, microphone, and the like. Computer 100 can be implemented using any suitable computer, such as, for example, an IBM eServer computer or IntelliStation computer, which are products of International Business Machines Corporation, located at Armonk, N.Y. Although the depicted representation shows a computer, other embodiments of the present invention may be implemented in other types of data processing systems, such as a network computer. Computer 100 also preferably includes a Graphical User Interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 preferably employs a Peripheral Component Interconnect (PCI) local bus architecture. Although the depicted example employs a PCI bus, other bus architectures such as Accelerated Graphics Port (AGP) and Industry Standard Architecture (ISA) may be used.

Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, Local Area Network (LAN) adapter 210, SCSI HBA 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for keyboard and mouse adapter 220, modem 222, and additional memory 224. SCSI HBA 212 provides a connection for hard disk drive 226, tape drive 228, and CD-ROM drive 230. Typical PCI local bus implementations can support three or four PCI expansion slots or add-in connectors.

An Operating System (OS) runs on processor 202 and is used to coordinate and provide control of various components within data processing system 200 in FIG. 2. The OS may be a commercially available OS such as AIX, a version of Unix, which is available from IBM. An object oriented programming system such as Java may run in conjunction with the OS and provides calls to the OS from Java programs or applications executing on data processing system 200. “Java” is a trademark of Sun Microsystems, Inc. Instructions for the OS, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash Read-Only Memory (ROM), equivalent nonvolatile memory, or optical disk drives and the like, may be used in addition to or in place of the hardware depicted in FIG. 2. Also, the processes of the present invention may be applied to a multiprocessor data processing system.

Data processing system 200 may include some type of network communication interface, such as LAN adapter 210, modem 222, or the like. As another example, data processing system 200 may be a stand-alone system configured to be bootable without relying on some type of network communication interface, whether or not data processing system 200 is composed of some type of network communication interface. As a further example, data processing system 200 may be a Personal Digital Assistant (PDA), which can be configured with ROM and/or flash ROM to provide nonvolatile memory for storing operating system files and/or user-generated data.

The depicted example in FIG. 2 and above-described examples are not meant to imply architectural limitations on the present invention. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more of peripheral devices 226, 228, 230.

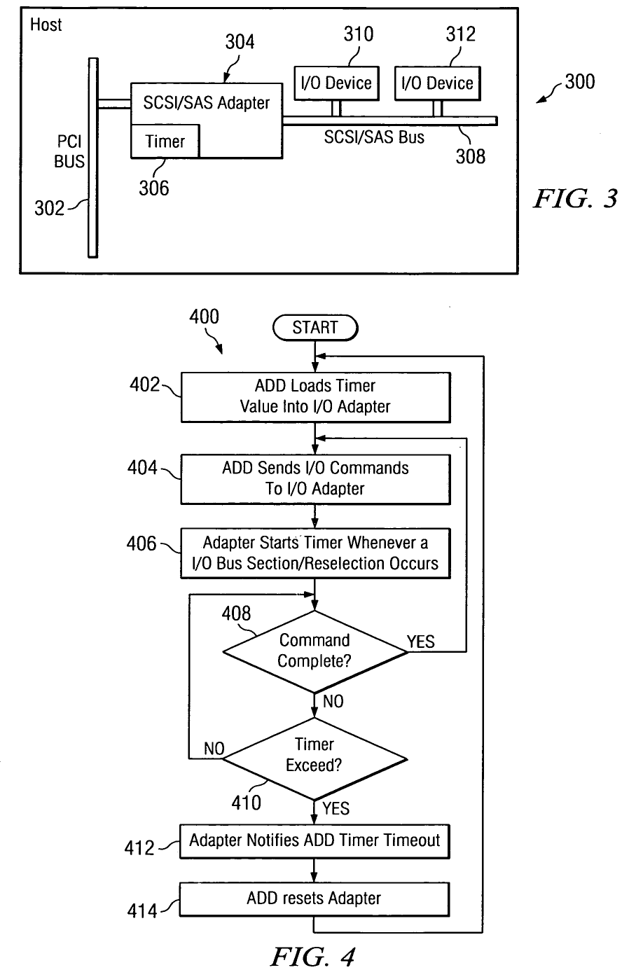

With reference now to FIG. 3, a block diagram of an exemplary Host is depicted in which a preferred embodiment of the present invention may be implemented. For example, HBA 300 can be implemented with SCSI HBA 212 depicted in FIG. 2. Also, Host 300 can represent an AIX/UNIX host system, and can include SCSI/SAS I/O adapter 304 connected to PCI bus 302. Also, SCSI/SAS adapter I/O 304 can include timer 306. For this exemplary embodiment, timer 306 can be implemented in software and/or firmware. An ADD (not shown) is associated with an OS residing, for example, in memory 204 and executed by processor 202 depicted in FIG. 2. In the depicted example, SCSI/SAS adapter 304 is connected to PCI local bus 302 by direct component connection. As such, SCSI/SAS adapter 304 provides a connection for I/O devices 310, 312 via SCSI/SAS bus 308. For example, each of I/O devices 310, 312 can be a hard disk drive, tape drive or other type of peripheral device (e.g., hard disk drive 226, tape drive 228, or CD-ROM drive 230 depicted in FIG. 2). For illustrative purposes only, and not intended as an architectural limitation on the present invention, it may be assumed that I/O device 310 represents a hard disk drive, and I/O device 312 represents a tape drive.

With reference now to FIG. 4, a flow chart of an exemplary method for mitigating and recovering from the inefficient behavior of one or more peripheral devices on a shared I/O bus is depicted in accordance with a preferred embodiment of the present invention. Method 400 can be performed, for example, by suitable computer instructions stored in memory 204 and executed, at least in part, by processor 202 (e.g., as depicted in FIG. 2). As such, exemplary method 400 begins by an ADD (e.g., associated with a host OS, such as, for example, an AIX/UNIX host residing in memory 204) loading a predetermined time-out threshold value into a timer (e.g., timer 306) of an appropriate I/O adapter (e.g., SCSI/SAS adapter 304) for the peripheral device involved (step 402). For example, such a peripheral device can be I/O device 312 representing a tape drive (e.g., tape drive 228 in FIG. 2). As mentioned earlier, the predetermined time-out value can be set based on the maximum time interval that any particular device is allowed to remain on the shared bus.

Next, typically as dictated by user/performance requirements, the ADD (not shown) sends suitable I/O commands to the I/O adapter (e.g., SCSI/SAS adapter 304) involved (step 404). Responsive to receiving a suitable I/O command, the I/O adapter (e.g., SCSI/SAS adapter 304) starts the operation of timer 306 if an I/O bus selection or reselection operation has begun (step 406). While timer 306 is timing down (or timing up, as the case may be), the I/O adapter (e.g., SCSI/SAS adapter 304) associated with that peripheral device (e.g., tape drive or I/O device 312) monitors the I/O operation (e.g., media access or read/write operation) associated with the I/O command involved (step 408). If (at step 408) the I/O operation has not been completed, the I/O adapter (e.g., SCSI/SAS adapter 304) involved determines whether or not the time-out threshold value (e.g., for timer 306) has been reached or exceeded (step 410). If not, then the flow proceeds back to step 408. If (at step 408) the I/O operation has been completed, then the flow proceeds back to step 404.

Returning to step 410, if the I/O operation has not been completed, and the timer (306) has timed out (or otherwise exceeded the loaded timer threshold value), then the I/O adapter (e.g., SCSI/SAS adapter 304) involved sends a suitable timer (e.g., time-out) notification message to the ADD (step 412). Responsive to receipt of the timer notification message, the ADD can reset the I/O adapter (e.g., SCSI/SAS 304) involved (step 414), which causes the current device to disconnect (e.g., I/O device 312) and thus allows another device (e.g., I/O device 310) to be connected to the shared bus (e.g., PCI bus 302).

Thus, in accordance with a preferred embodiment, an HBA for a peripheral drive monitors the time duration that a shared I/O bus is busy, and interrupts the operation of that drive if a predetermined time threshold is exceeded. The HBA can cause the bus to be reset, if necessary, and thus cause the device utilizing the bus to be disconnected so that another devices can access the bus. Also, the present invention provides a method for identifying a peripheral device that is inefficiently tying up a shared I/O bus, so that an appropriate procedure can be initiated to recover from that device's inefficient behavior. As such, the present invention also applies to all shared bus topologies including parallel and serial buses. For example, the present invention can also mitigate the inefficient behavior of a peripheral device on a Serial Attached SCSI (SAS) bus where a single SAS Initiator (HBA) is connected to multiple SAS devices through an Edge Expander. Thus, the present invention provides a method for substantially improving the performance of a parallel or serial I/O bus and also the host system involved.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for recovering from inefficient behavior of a peripheral device on a shared I/O bus, comprising:
a bus;
a peripheral device;
an I/O adapter, said I/O adapter coupled to said bus and said peripheral device; and
a timer, said timer associated with said I/O adapter and said peripheral device, said timer including a predetermined threshold time value, said I/O adapter operable to;
monitor said timer and a duration of time that said peripheral device is coupled to said bus; and
uncouple said peripheral device from said bus if said duration of time is equal to or exceeds said predetermined threshold time value.

2. The system of claim 1, wherein said bus comprises a parallel bus or a serial bus.

3. The system of claim 1, wherein said peripheral device comprises a tape drive.

4. The system of claim 1, wherein said I/O adapter comprises a SCSI I/O adapter.

5. The system of claim 1, wherein said uncouple operation comprises an I/O bus reset operation.

6. The system of claim 1, wherein said I/O adapter comprises a Host Bus Adapter.

7. The system of claim 1, further comprising:
a processor unit, said processor unit coupled to said I/O adapter; and
an adapter device driver, said adapter device driver coupled to said processor unit and operable to uncouple said peripheral device from said bus responsive to receipt of a time-out message, said I/O adapter further operable to send a time-out message to said adapter device driver if said duration of time is equal to or exceeds said predetermined threshold time value.

8. A method for recovering from inefficient behavior of a peripheral device on a shared I/O bus, comprising:
coupling a peripheral device to a bus;
storing, in a timer, a predetermined threshold time value;
monitoring said timer and a duration of time that said peripheral device is coupled to said bus; and
uncoupling said peripheral device from said bus if said duration of time is equal to or exceeds said predetermined threshold time value.

9. The method of claim 8, wherein said bus comprises a parallel bus or a serial bus.

10. The method of claim 8, wherein said peripheral device comprises a tape drive.

11. The method of claim 8, further comprising the step of coupling a SCSI I/O adapter to said bus.

12. The method of claim 8, wherein the uncoupling step comprises resetting said bus.

13. The method of claim 11, wherein said SCSI I/O adapter comprises a Host Bus Adapter.

14. The method of claim 8, further comprising:
coupling a processor unit to an I/O adapter and an adapter device driver;
said I/O adapter conveying a time-out message if said duration of time is equal to or exceeds said predetermined threshold time value; and
said adapter device driver uncoupling said peripheral device from said bus if said time-out message is received.

15. A computer program product in a computer readable medium, said computer program product comprising:
first instructions for coupling a peripheral device to a bus;
second instructions for storing, in a timer, a predetermined threshold time value;
third instructions for monitoring said timer and a duration of time that said peripheral device is coupled to said bus; and
fourth instructions for uncoupling said peripheral device from said bus if said duration of time is equal to or exceeds said predetermined threshold time value.

16. The computer program product of claim 15, wherein said bus comprises a parallel bus or a serial bus.

17. The computer program product of claim 15, wherein said peripheral device comprises a tape drive.

18. The computer program product of claim 15, further comprising:
fifth instructions for coupling a SCSI I/O adapter to said bus.

19. The computer program product of claim 15, wherein the fourth instructions comprises instructions for resetting said bus.

20. The computer program product of claim 15, further comprising:
sixth instructions for coupling a processor unit to an I/O adapter and an adapter device driver;
seventh instructions for conveying a time-out message if said duration of time is equal to or exceeds said predetermined threshold time value; and
eight instructions for uncoupling said peripheral device from said bus if said time-out message is received.
